(19) United States
(12) Patent Application Publication
(10) Pub. No.: US 2012/0005061 A1
(43) Pub. Date: Jan. 5, 2012

(54) METHOD AND SYSTEM FOR FACILITATING PROPERTY SALES AND GIFTING

(76) Inventor: Ralf Schirg, St. Paul, MN (US)

(21) Appl. No.: 12/890,255

(22) Filed: Sep. 24, 2010

Related U.S. Application Data
(60) Provisional application No. 61/245,503, filed on Sep. 24, 2009.

(51) Int. Cl. G06Q 40/00; G06Q 50/00

(52) U.S. Cl. 705/37; 705/313

(57) ABSTRACT

A method and system for facilitating property sales and gifting, in particular real and personal property sales and gifting. A method and system for providing an online platform for property sales and gifting amongst various users of the method and system, including at least one property seller, at least one property recipient, at least one voter who votes to elect a property recipient and at least one donor of funds to provide funding for the ultimate property purchase.

### RELATED APPLICATIONS

This application claims priority to U.S. Provisional Application Serial No. 61/245,503 filed Sep. 24, 2009 entitled “Method and System for Facilitating Property Sales and Gifting” and is hereby incorporated by reference.

### BACKGROUND OF THE INVENTION

This invention relates to a method and system for facilitating property sales and gifting.

In our current economic times, there has been a ripple effect of cultural and societal implications, including job or income loss, as well as the loss of people's homes to foreclosure, or loss of possessions (real or personal property including land, automobiles, boats, electronics, furnishings, etc).

In the example of homes, the fortunate few who are able to keep their homes are still often unable to afford their mortgages, due to interest-rate hikes on credit cards or debt or due to loss of income or job loss. The problem is exacerbated by the person's inability to sell their home for a fair price, if at all, due to an already saturated seller's market. Even in the best-case scenario in which a person is able to continue to afford their mortgage, if they choose to sell in order to obtain a larger property (for example, due to family growth) or if they need to relocate for employment purposes, they are being forced to sell at a drastically lower rate than they ever imagined when they purchased the home, primarily due to depressed appraisal values. That leaves them walking away from the deal with either no money or having to borrow or bring money to the table from any savings they have left to close the deal and thereby, take a loss on the property, possibly go into debt and/or forfeit their savings.

Property “value” is also relevant when considering the value of personal or intellectual property items, including, but not limited to: cars, boats, recreational vehicles of all kinds (four-wheelers, motorized bikes, etc), farm equipment and vehicles, inventions, movie or TV scripts, novels, other creative endeavors and the like. Additionally, communication technologies (ie, PDA's, laptop computers, etc) and communication and technology platforms such as the internet and search engines thereon and social media tools such as Facebook, MySpace, Twitter, blogs and websites, have made it exceedingly easier for local and social communications in order to promote personal and business interests. For example, a writer may want to promote a script or story that he or she wishes to fully fund and offer to a movie or TV director for further development and needs a public and community vehicle through which to accomplish this.

Therefore, there exists a need to provide a creative solution to people, in which they are able to sell their real or personal property at fair market values and prices, which uses social media avenues to promote said property and fund and advertise personal projects or property in order to bring them to completion or fruition. There also exists a need to be able to raise funds to purchase property or finance personal and intellectual projects, such that people will not go into debt (further or any) to pursue such endeavors. Further, there exists a need to do these types of transactions and activities while maintaining a spirit of community and charity.

### SUMMARY OF THE INVENTION

One aspect of the present invention is to facilitate home sales or personal or intellectual property sales and/or financing via a website and/or the internet (hereinafter “online”).

Another aspect of the present invention is to facilitate such property sales or financing online, such as to support the recovery of the economic circumstances of people and boost the economy generally in the United States.

Yet another aspect of the present invention is to promote the sale and advertisement of such property free and clear of a mortgage or debt or obligations to third parties.

Yet another aspect of the present invention is to provide a method of gifting or providing financing in support of acquiring or promoting the sale of such property.

Yet another aspect of the present invention is to provide a method of making a charitable donation to another person to obtain or promote the sale of such property.

### BRIEF DESCRIPTION OF THE INVENTION

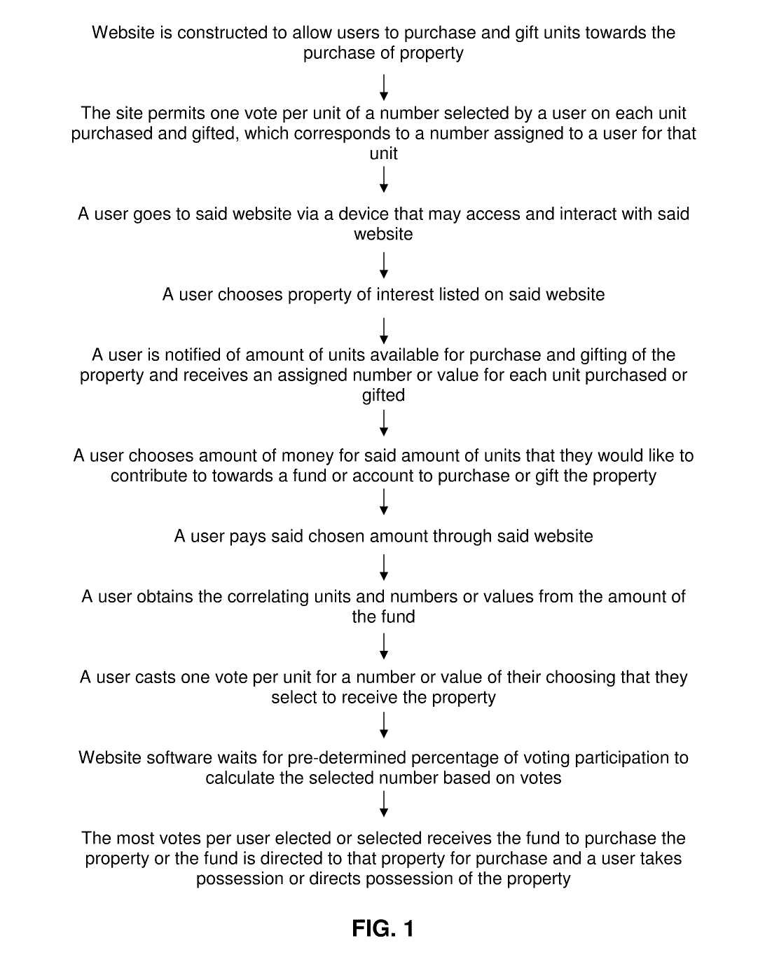

FIG. 1 is a flowchart illustrating at least one embodiment of the method and system of the present invention.

### DETAILED DESCRIPTION OF THE INVENTION

In general, the present invention includes a web-based system and method for facilitating home, personal or real property sales and gifting. In at least one embodiment, the present invention includes: a system and method for facilitating property sales comprising: at least one website, at least one device to interact with said at least one website, at least two users of said system; and at least one listed piece of property for transfer from one party to another, wherein said at least one listed piece of property is transferred between said at least two users of said system while preserving a predetermined, stated value of said property and said property is transferred between said at least two users of said system substantially free and clear of any debt.

In at least one embodiment of the present invention, a website is used and at least one device is contemplated for use and interaction with said website. Websites and web-site like platforms, as would be understood by ordinary persons and ones of ordinary skill in the website-technology related arts, are contemplated herein. Devices contemplated for use and interaction with websites may include, but are not limited to, personal digital assistants, hand-held devices known by ordinary skill and persons of ordinary skill in the hand-held device arts, computers, mobile phones, communication technology platforms including, but not limited to, devices that utilize GPS and triangulation technologies and related interactive applications.

In at least one embodiment of the present invention, users of the system and method may include, but are not limited to, entities or individuals or a combination thereof, sellers of property, potential recipients of property, donors of money, voters to determine who receives property, listing agents, web hosts or managers, advertisers, financing companies and realtors, or others not named that would be ordinary persons of skill in the property transfer and/or web-driven business arts.

In at least one embodiment of the present invention, property may include, but is not limited to, real property (for example, homes, real estate, residential or commercial property), personal property (for example, vehicles, furniture, computers, electronics, appraisable property items such as antiques, comic books, stamp collections, works of art, books) or items in the field or the subject of intellectual property (copyrightable, trademarkable or patentable works, such as movie scripts, screenplays, books and pending or registered rights regarding patents, trademarks and copyrights).

In at least one embodiment of the present invention, property for transfer will have a pre-determined value set by a user (for example, the seller of a home will set the purchase price of their home on a website). In at least one embodiment of the present invention, the value set may or may not be determinative of socially perceivable or economically-determinable fair market values. In at least one embodiment of the present invention, the property for transfer will preferably transfer from one user of the system and method to another substantially free and clear of any debt. In at least one embodiment of the present invention, the definition of “debt” may include, but is not limited to, liens, mortgages, security interests, loans, judgments and promissory notes.

In at least one embodiment of the invention, a user may be host to showing personal or real property that are for sale and collect the money necessary for the sale. In at least one embodiment of the present invention, through a website, users will be able to purchase units or options (for example, units in a fund) and an opportunity at being selected to become the owner of the house (for example, by voting of the “unit” holders or buyers-in-fact). In at least one embodiment of the present invention, where supported and permissible by the laws of city, county, state and federal governments, such unit purchase (and all of the subsequent transactional methods described herein) may or may not be constructed to constitute gaming, lottery, raffle or other game of chance. It should be further noted that the use of “units” and “funds” with regards to the present invention do not contemplate the use of the words as would be associated with securities-related matters.

In at least one embodiment of the present invention, the price of a unit may be determined by the value of the fund, which may cover the established price of the real or personal property to be sold (which may include any taxes and fees, as well as a service fee to be charged by the company). In at least one embodiment of the present invention, the number of units may be, but are not limited to, anywhere from 2500-6000, probably in the range of US$49.00-US$399.00, depending on the value of the property/fund. When a user (this may be a buyer, a seller or someone just “gifting” money towards a purchase or sale, as otherwise described herein) buys a unit with their credit card, they may be assigned numbers in order of when the purchase was made and at the time of the purchase.

In at least one embodiment of the present invention, software code may be written to capture aspects of transactional details that are desirable. For example, software may be created to capture times of, for example, the purchaser's logon transaction, purchase of units transactions, and voting transactions, in order to determine the effective time of the number assigned to that person or when the total votes for a particular person or piece of property have been completed. The number assigned to a user may be, for example, between 1 and the highest number of units for that chosen piece of property, and the purchaser may or may not know the number that they have been assigned. In at least one embodiment of the present invention, a user may be given notification (for example, a reply email or text message) indicating the exact details of the logon, purchase of units and voting time, and that a purchase for the unit has been made, such that the transaction is solidified and may provide later proof of when the voted number was distributed in order to transfer ownership of the property to the holder of said voted number. In at least one embodiment of the present invention, a user may be given a number that they actually advertise and campaign with in order to get other purchasers to participate specifically in their purchase of real or personal property.

In at least one embodiment of the present invention, for each unit a user buys, the user earns the right to cast a vote for (or elect) the number (that has been assigned to one purchaser) that they feel should receive the selected home. In at least one embodiment of the present invention, a user may have no knowledge of the holder of the number that they possess, although it may be that they vote for their very own number. In at least one embodiment of the present invention, the user does have knowledge of the unit or number that they possess. In at least one embodiment of the present invention, a user participates with no intention of positioning themselves to be eligible for property and simply wishes to participate in order to be eligible to gift to another user.

In at least one embodiment of the present invention, all users will cast their votes in order to complete the transaction, guaranteeing 100% participation of the users of units for the selected property. In at least one embodiment of the present invention, once all of the units in the chosen property have been sold and all votes are cast, the number that received the most votes will be calculated and, ultimately, the property will be forwarded onto the purchaser with the selected or elected number.

For example, once the selected or elected number is made known or determined, a user may receive either the fund generated by unit purchases, to put towards purchase of the selected property, minus any associated fees and taxes (for example, for the company, state and federal taxes) or the fund will be put towards the purchase of property directly and possession of the property will be passed to the elected or selected participant. In such example, the fund's money may or may not be held in escrow from the day it's opened until all units are sold and the votes have been cast. In at least one embodiment of the present invention, a condition of being selected may be that the money must be put towards full payment of the property, minus any applicable taxes and fees.

In at least one embodiment of the present invention, at this point, the fund may be transferred to an account to complete the transaction of property purchase and transfer (for example, the closing company's escrow account for completion of the real estate or personal property sales transaction). In at least one embodiment of the present invention, in the event that not all units or a predetermined minimum number get sold, the company may reserve the right to cancel the fund, and refund all unit owners their investment, minus a US$5.00 administration fee.

In at least one embodiment of the present invention, money paid to a fund may be given or gifted as a charitable donation to the user possessing the ultimately selected number (whether voted or otherwise chosen). In at least one embodiment of the present invention, the transaction may conclude with the chosen user donating their fund or property to another person who may take possession of the fund or property, as, for example, a gift or charitable act.

In at least one embodiment of the present invention, the philosophy behind the invention is, in part, to bring people together in a communal way to enable someone (possibly themselves of course) to buy a house or other property free and clear of debt, mortgages and liens for a reasonable amount of money and/or to promote the financing of a personal project in order to bring that project to further development and fruition by themselves or with the help of a third-party. In at least one embodiment of the invention, social media may be used to generate publicity, voting and participation, such social media including, but not limited to, Facebook, Twitter, MySpace, blogs, websites and the internet.

In at least one embodiment of the present invention, it also provides an opportunity to gift at least a portion of that reasonable amount to another for the purchase of a home or personal property.

At a minimum, the present invention provides a boost to get the U.S. housing market or U.S. markets generally, moving and also assist in bringing home values up in a given neighborhood or property values up, in general.

In the example of real property and/or homes, since the county in which a house resides will record the sale of the house at a fair market price where the seller needs, most probably higher than a current, depressed appraisal value, the property will become a comparable sale for other homeowners in the area. The idea is to create a win/win situation for everyone, while having fun during the process.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

I claim:

1. A system for facilitating property sales comprising: at least one website, at least one device to interact with said at least one website, at least two users of said system; and at least one listed piece of property for transfer from one party to another, wherein said at least one listed piece of property is transferred between said at least two users of said system while preserving a predetermined, stated value of said property and said property is transferred between said at least two users of said system substantially free and clear of any debt.

2. The system of claim 1 wherein said at least one listed piece of property comprises a parcel of real property.

3. The system of claim 1 wherein said at least one listed piece of property comprises a piece of intellectual property.

4. The system of claim 1 wherein said at least one device to interact with said at least one website comprises a personal digital assistant (PDA).

5. The system of claim 1 wherein said at least one device to interact with said at least one website comprises a computer.

6. The system of claim 1 wherein said at least one device to interact with said at least one website comprises a mobile phone equipped with applications designed to interact with said at least one website.

7. The system of claim 1 wherein said at least two users of said system comprise at least one seller of property.

8. The system of claim 1 wherein said at least two users of said system comprises at least one potential recipient of property.

9. The system of claim 1 wherein said at least two users of said system comprises at least one listing agent of property.

10. The system of claim 8 wherein said at least two users of said system further comprises at least one donor of money, who contributes said money to a fund towards the purchase of said at least one listed piece of property, said individual being given a corresponding right to vote for which said at least one potential recipient of property should received said property.

11. The system of claim 10 wherein said at least one donor of money further comprising an individual who is not eligible to be said at least one potential recipient of said property.

12. The system of claim 1 wherein said predetermined, stated value of said property comprises the purchase price of a piece of real property determined by a user who owns said property, notwithstanding the economically-determined fair market value of said property.

13. A system for selling and gifting of property comprising: at least one website, at least one device to interact with said at least one website, at least two users of said system; and at least one listed piece of property for transfer from one party to another, wherein said at least one listed piece of property is transferred between said at least two users of said system and wherein said property is transferred as determined by voting.

14. The system of claim 13 wherein said at least one listed piece of property comprises at least two residential homes of substantially similar market value.

15. The system of claim 13 wherein said at least two users of a system comprises at least one potential recipient of property and a donor of money, who donates said money towards the purchase of said property.

16. The system of claim 15 wherein said at least one potential recipient of property selects a property to become eligible to receive and then campaigns for donations and corresponding votes to raise the purchase price of the property.

17. The system of claim 15 wherein said donor of money, who donates said money towards the purchase of said property contributes money into a fund that is designated to be applied to the property with the most votes gained by said potential recipient of property.

18. A method of transferring property from one party to another party, comprising the steps of:
Providing at least one interactive website;
Listing at least one piece of property for transfer on said interactive website;
Providing at least one party eligible to receive said property; and
Providing at least one party to donate money for purchase of said property
Wherein said at least one party eligible to receive said property becomes eligible to receive said property when said donated money for purchase of said property has reached a pre-determined amount to substantially satisfy the purchase price of said property.

19. The method of claim 18 wherein said at least one party eligible to receive said property comprises at least three parties eligible to receive said property.

20. The method of claim 18 wherein providing at least one interactive website comprises providing an interactive website through which all transactions of the property transfer can be substantially completed.
